(19) United States
(12) Patent Application Publication
(10) Pub. No.: US 2018/0081289 A1
(43) Pub. Date: Mar. 22, 2018

(54) TONER FOR DEVELOPING ELECTROSTATIC IMAGES

(71) Applicant: ZEON CORPORATION, Tokyo (JP)

(72) Inventors: Takeru Chiba, Tokyo (JP); Hiroshi Nakatani, Tokyo (JP)

(73) Assignee: ZEON CORPORATION, Tokyo (JP)

(21) Appl. No.: 15/558,095

(22) PCT Filed: Mar. 9, 2016
(86) PCT No.: PCT/JP2016/057363

§ 371 Date: Sep. 13, 2017

(30) Foreign Application Priority Data
Mar. 24, 2015 (JP) 2015-061584

(51) Int. Cl. G03G 9/09; G03G 9/08; G03G 9/087; G03G 9/097

(52) U.S. Cl. CPC G03G 9/0926; G03G 9/0819; G03G 9/09741; G03G 9/08711; G03G 9/0827

(57) ABSTRACT

The present invention is to provide a toner for developing electrostatic images, which is configured to have excellent low-temperature fixability, resistance to filming, inhibition of fog in a high temperature and high humidity environment, and excellent printing durability in a high temperature and high humidity environment (resistance to fog under load of continuous printing). Disclosed is a toner for developing electrostatic images, including colored resin particles containing a binder resin and a colorant, and external additives, wherein, as the external additives, the toner contains the specific amount of the zinc oxide fine particles having the specific particle diameter and the specific amount of the alumina fine particles having the specific particle diameter.

### TECHNICAL FIELD

The present invention relates to a toner for developing electrostatic images, which can be used for development in image forming devices using electrophotography, such as a copy machine, a facsimile machine and a printer.

### BACKGROUND ART

Developers that have been used for common electrophotography obtains desired flowability and charging property by attaching an external additive to the surface of colored resin particles. As the external additive, fine particles composed of an inorganic or organic substance have been widely used. As such an external additive, for example, metal oxide particles, resin particles, and particles obtained by surface-treating them have been widely used. Of them, especially, particles of a metal oxide such as silica, titania, alumina and zinc oxide, particles of a fatty acid metal salt, and particles obtained by hydrophobizing them, are widely used. Also, combinations thereof are generally used.

For example, Patent Document 1 discloses a toner for electrostatic development, comprising toner particles and zinc oxide fine particles attached to the surface of the toner particles, the toner particles mainly comprising a thermoplastic resin-based binder and a pigment, and the zinc oxide fine particles being coated with a modified silicone oil having at least one organic group selected from an amino group and an epoxy group. Patent Document 1 also discloses that the toner provides excellent durability and images with less fog.

Patent Document 2 discloses a negatively chargeable toner obtained by covering polyester-based spherical resin particles containing colored particles, with hydrophobized external additives including at least negatively chargeable silica particles, rodlike polyhedral hexagonal zinc oxide particles, and positively chargeable silica particles. Patent Document 2 also discloses that the toner has excellent charge stability, causes no toner leakage or scattering, and produces printed images free of unevenness in image density.

Patent Document 3 discloses a positively chargeable toner comprising toner base particles surface-treated with an external additive containing zinc oxide fine particles subjected to a treatment for imparting positive charging property and to a treatment with silicone oil at a specified treatment amount ratio. Patent Document 3 also discloses that the toner causes no decrease in charge amount even after a long period of use, and the toner provides images resistant to toner scattering or fog.

Patent Document 4 discloses that an alumina powder for a toner additive, the powder having a specified shape, particle diameter and particle size distribution, is used as a developer for electrophotography. In paragraph [0035] in the Description of Patent Document 4, it is described that a developer that is free of drum filming and a developer for electrophotography that is excellent in increasing image quality and in durability, are obtained by the use of the alumina powder.

However, even if the external additives disclosed in these patent documents are used, it is difficult to simultaneously exert various toner properties required high-speed printing in recent years at a high level, such as stable fog inhibition in all environments in extremely different conditions, low-temperature fixability, filming property, and maintaining the initial toner conveyance amount in continuous printing. Therefore, toners for developing electrostatic images are needed to be able to simultaneously exert these various toner properties at a high level.

### CITATION LIST

Patent Document 1: Japanese Patent Application Laid-Open (JP-A) No. HS-325511

Patent Document 2: JP-A No. 2007-121481

Patent Document 3: JP-A No. 2012-68497

Patent Document 4: JP-A No. 2000-250251

### SUMMARY OF INVENTION

### Technical Problem

An object of the present invention is to provide a toner for developing electrostatic images which is configured to simultaneously exert some of toner properties that have been required of and have not been achieved by conventional toners for developing electrostatic images, that is, excellent low-temperature fixability, resistance to filming, inhibition of initial fog in a high temperature and high humidity environment, and printing durability in a high temperature and high humidity environment (resistance to fog under load of continuous printing).

### Solution to Problem

As a result of diligent research on external additives that constitute a toner for developing electrostatic images along with colored resin particles, the inventors of the present invention found that the above-mentioned object can be achieved by using a combination of a specific amount of zinc oxide fine particles having a specific particle diameter and a specific amount of alumina fine particles having a specific particle diameter as external additives, and incorporating them in a toner for developing electrostatic images.

According to the present invention, a toner for developing electrostatic images is provided, which is a toner comprising colored resin particles containing a binder resin and a colorant, and external additives, wherein, as the external additives, the toner contains zinc oxide particles having a number average particle diameter of from 0.1 to 2.0 μm and alumina particles having a number average particle diameter of from 0.05 to 1.0 μm; the content of the zinc oxide particles is from 0.05 to 1.0 part by mass with respect to 100 parts by mass of the colored resin particles; and the content of the alumina particles is from 0.05 to 1.0 part by mass with respect to 100 parts by mass of the colored resin particles.

In the present invention, a content ratio by mass of the alumina particles to the zinc oxide particles is preferably in a range of from 1:0.6 to 1:5.

In the present invention, a shape of the zinc oxide particles is preferably a plate shape.

In the present invention, it is preferable that as an external additive, the toner further contains inorganic fine particles A having a number average particle diameter of from 5 to 25 nm, and a content of the inorganic fine particles A is from 0.1 to 2.0 parts by mass with respect to 100 parts by mass of the colored resin particles.

In the present invention, it is preferable that the inorganic fine particles A are positively chargeable.

In the present invention, it is preferable that as an external additive, the toner further contains inorganic fine particles B having a number average particle diameter of from 30 to 200 nm, and a content of the inorganic fine particles B is from 0.1 to 2.0 parts by mass with respect to 100 parts by mass of the colored resin particles.

In the present invention, it is preferable that the colored resin particles are positively chargeable.

In the present invention, it is preferable that the toner for developing electrostatic images is positively chargeable.

### Advantageous Effects of Invention

According to the present invention, the toner for developing electrostatic images, which is configured to have all of the properties of excellent low-temperature fixability, resistance to filming, inhibition of fog in a high temperature and high humidity (H/H) environment, and excellent printing durability in a high temperature and high humidity (H/H) environment, is obtained by incorporating the specific amount of the zinc oxide fine particles having the specific particle diameter and the specific amount of the alumina fine particles having the specific particle diameter in the toner as the external additives.

### DESCRIPTION OF EMBODIMENTS

The toner for developing electrostatic images according to the present invention is a toner comprising colored resin particles containing a binder resin and a colorant, and external additives, wherein, as the external additives, the toner contains zinc oxide particles having a number average particle diameter of from 0.1 to 2.0 μm and alumina particles having a number average particle diameter of from 0.05 to 1.0 μm; the content of the zinc oxide particles is from 0.05 to 1.0 part by mass with respect to 100 parts by mass of the colored resin particles; and the content of the alumina particles is from 0.05 to 1.0 part by mass with respect to 100 parts by mass of the colored resin particles.

Hereinafter, the toner for developing electrostatic images according to the present invention (hereinafter it may be simply referred to as “toner”) will be described.

The toner of the present invention comprises colored resin particles containing a binder resin and a colorant, and external additives.

### 1. Method for Producing Colored Resin Particles

Generally, methods for producing colored resin particles are broadly classified into dry methods such as a pulverization method and wet methods such as an emulsion polymerization agglomeration method, a suspension polymerization method and a solution suspension method. Wet methods are preferred since toners having excellent printing properties such as image reproducibility can be easily obtained. Among wet methods, polymerization methods such as an emulsion polymerization agglomeration method and a suspension polymerization method are preferred, since toners which have relatively small particle size distribution in micron order can be easily obtained. Among polymerization methods, a suspension polymerization method is more preferred.

The emulsion polymerization agglomeration method is a method for producing colored resin particles by polymerizing emulsified polymerizable monomers to obtain a resin microparticle emulsion, and aggregating the resulting resin microparticles with a colorant dispersion, etc. The solution suspension method is a method for producing colored resin particles by forming droplets of a solution in an aqueous medium, the solution containing toner components such as a binder resin and a colorant dissolved or dispersed in an organic solvent, and removing the organic solvent. Both methods can be carried out by known methods.

The colored resin particles of the present invention can be produced by employing the wet method or the dry method. Among the wet methods, the suspension polymerization method is preferred and is carried out by the following processes.

### (A) Suspension Polymerization Method

### (A-1) Preparation Process of Polymerizable Monomer Composition

First, a polymerizable monomer, a colorant, a charge control agent and other additives added as needed, such as a release agent, are mixed to prepare a polymerizable monomer composition. For example, a media type dispersing machine is used for the mixing in the preparation of the polymerizable monomer composition.

In the present invention, the polymerizable monomer means a monomer having a polymerizable functional group, and the polymerizable monomer is polymerized to be a binder resin. As a main component of the polymerizable monomer, a monovinyl monomer is preferably used. As the monovinyl monomer, examples include, but are not limited to, styrene; styrene derivatives such as vinyl toluene and α-methylstyrene; acrylic acid and methacrylic acid; acrylic acid esters such as methyl acrylate, ethyl acrylate, propyl acrylate, butyl acrylate, 2-ethylhexyl acrylate and dimethylaminoethyl acrylate; methacrylic acid esters such as methyl methacrylate, ethyl methacrylate, propyl methacrylate, butyl methacrylate, 2-ethylhexyl methacrylate and dimethylaminoethyl methacrylate; nitrile compounds such as acrylonitrile and methacrylonitrile; amide compounds such as acrylamide and methacrylamide; and olefins such as ethylene, propylene and butylene. These monovinyl monomers may be used alone or in combination of two or more kinds. Of them, styrene, styrene derivatives, and acrylic acid esters or methacrylic acid esters are suitably used for the monovinyl monomer.

In order to improve hot offset and storage stability, it is preferable to use a crosslinkable polymerizable monomer together with the monovinyl monomer. The crosslinkable polymerizable monomer means a monomer having two or more polymerizable functional groups. As the crosslinkable polymerizable monomer, examples include, but are not limited to, aromatic divinyl compounds such as divinyl benzene, divinyl naphthalene and derivatives thereof; ester compounds such as ethylene glycol dimethacrylate and diethylene glycol dimethacrylate, in which two or more carboxylic acids having a carbon-carbon double bond are esterified to alcohol having two or more hydroxyl groups; other divinyl compounds such as N,N-divinylaniline and divinyl ether; and compounds having three or more vinyl groups. These crosslinkable polymerizable monomers can be used alone or in combination of two or more kinds.

In the present invention, it is desirable that the amount of the crosslinkable polymerizable monomer is generally from 0.1 to 5 parts by mass, and preferably from 0.3 to 2 parts by mass, with respect to 100 parts by mass of the monovinyl monomer.

Also, it is preferable to use a macromonomer as a part of the polymerizable monomer, since the balance between the storage stability and low-temperature fixability of the toner thus obtained can be improved. The macromonomer is a reactive oligomer or polymer having a polymerizable carbon-carbon unsaturated double bond at the end of a polymer chain and generally having a number average molecular weight of from 1,000 to 30,000. The macromonomer is preferably one that can provide a polymer having a higher glass transition temperature (hereinafter may be referred to as “Tg”) than a polymer obtained by polymerizing the monovinyl monomer.

It is desirable that the amount of the macromonomer is preferably from 0.03 to 5 parts by mass, and more preferably from 0.05 to 1 part by mass, with respect to 100 parts by mass of the monovinyl monomer.

In the present invention, a colorant is used. To produce a color toner, a black colorant, a cyan colorant, a yellow colorant and a magenta colorant can be used. As the black colorant, examples include, but are not limited to, carbon black, titanium black and magnetic powder such as zinc-iron oxide and nickel-iron oxide.

As the cyan colorant, examples include, but are not limited to, copper phthalocyanine compounds, derivatives thereof and anthraquinone compounds. More specifically, examples include, but are not limited to, C. I. Pigment Blue 2, 3, 6, 15, 15:1, 15:2, 15:3, 15:4, 16, 17:1 and 60.

As the yellow colorant, examples include, but are not limited to, compounds including azo pigments such as monoazo pigments and disazo pigments, condensed polycyclic pigments and dyes. More specifically, examples include, but are not limited to, C. I. Pigment Yellow 3, 12, 13, 14, 15, 17, 62, 65, 73, 74, 83, 93, 97, 120, 138, 155, 130, 181, 185, 186 and 213.

As the magenta colorant, examples include, but are not limited to, compounds including azo pigments such as monoazo pigments and disazo pigments, condensed polycyclic pigments and dyes. More specifically, examples include, but are not limited to, C. I. Pigment Red 31, 48, 57:1, 58, 60, 63, 64, 68, 81, 83, 37, 88, 89, 90, 112, 114, 122, 123, 144, 146, 149, 150, 163, 170, 184, 185, 187, 202, 206, 207, 209, 237, 238, 251, 254, 255 and 269, and C. I. Pigment Violet. 19.

In the present invention, these colorants can be used alone or in combination of two or more kinds. The amount of the colorant is preferably from 1 to 10 parts by mass, with respect to 100 parts by mass of the monovinyl monomer.

In the present invention, to improve the charging ability of the toner, a positively or negatively chargeable charge control agent is used.

The charge control agent is not particularly limited, as long as it is one that is generally used as a charge control agent for toners. Among charge control agents, a positively or negatively chargeable charge control resin is preferred, since the charge control resin is highly compatible with the polymerizable monomer and can impart stable charging ability (charge stability) to the toner particles. From the viewpoint of obtaining a positively chargeable toner, the positively chargeable charge control resin is more preferred. The toner of the present invention is preferably a positively chargeable toner.

As the positively chargeable charge control agent, examples include, but are not limited to, a nigrosine dye, a quaternary ammonium salt, a triaminotriphenylmethane compound, an imidazole compound, a polyamine resin, a quaternary ammonium group-containing copolymer, and a quaternary ammonium salt group-containing copolymer, which are preferably used as the charge control resin. As the negatively chargeable charge control agent, examples include, but are not limited to, azo dyes containing metal such as Cr, Co, Al and Fe; metal salicylate compounds; metal alkylsalicylate compounds; and sulfonic acid group-containing copolymers, sulfonate-containing copolymers, carboxylic acid group-containing copolymers and carboxylate-containing copolymers, which are preferably used as the charge control resin.

In the present invention, it is desirable that the amount of the charge control agent is generally from 0.01 to 10 parts by mass, and preferably from 0.03 to 8 parts by mass, with respect to 100 parts by mass of the monovinyl monomer. When the added amount of the charge control agent is less than 0.01 part by mass, fog may occur. On the other hand, when the added amount of the charge control agent is more than 10 parts by mass, soiling may occur in printing.

From the viewpoint of improving the releasing property of the toner from a fixing roller at the time of fixing, a release agent is preferably added to the polymerizable monomer composition. The release agent can be used without any particular limitation, as long as it is one that is generally used as a release agent for toners.

The release agent preferably contains at least one of an ester wax and a hydrocarbon wax. By using the waxes as the release agent, the balance between the low-temperature fixability and storage stability can be improved.

In the present invention, the ester wax is suitably used as the release agent. The ester wax is preferably a polyfunctional ester wax. As the polyfunctional ester wax, examples include, but are not limited to, pentaerythritol ester compounds such as pentaerythritol tetrapalmitate, pentaerythritol tetrabehenate and pentaerythritol tetrastearate; glycerin ester compounds such as hexaglycerin tetrabehenate tetrapalmitate, hexaglycerin octabehenate, pentaglycerin heptabehenate, tetraglycerin hexabehenate, triglycerin pentabehenate, diglycerin tetrabehenate and glycerin tribehenate; and dipentaerythritol ester compounds such as dipentaerythritol hexamyristate and dipentaerythritol hexapalmitate.

In the present, invention, the hydrocarbon wax is suitably used as the release agent. As the hydrocarbon wax, examples include, but are not limited to, a polyethylene wax, a polypropylene wax, a Fischer-Tropsch wax and a petroleum wax. Of them, a Fischer-Tropsch wax and a petroleum wax are preferred, and a petroleum wax is more preferred.

Besides the above release agents, a natural wax such as jojoba and a mineral wax such as ozokerite can be used, for example.

These release agents may be used alone or in combination of two or more kinds.

The amount of the release agent is preferably from 0.1 to 30 parts by mass, and more preferably from 1 to 20 parts by mass, with respect to 100 parts by mass of the monovinyl monomer.

As another additive, a molecular weight modifier is preferably used in the polymerization of the polymerizable monomer that is polymerized into a binder resin.

The molecular weight modifier is not particularly limited, as long as it is one that is generally used as a molecular weight modifier for toners. As the molecular weight modifier, examples include, but are not limited to, mercaptans such as t-dodecyl mercaptan, n-dodecyl mercaptan, n-octyl mercaptan and 2,2,4,6,6-pentamethylheptane-4-thiol; and thiuram disulfides such as tetramethyl thiuram disulfide, tetraethyl thiuram disulfide, tetrabutyl thiuram disulfide, N,N′-dimethyl-N,N′-diphenyl thiuram disulfide and N,N′-dioctadecyl-N,N′-diisopropyl thiuram disulfide. These molecular weight modifiers may be used alone or in combination of two or more kinds.

In the present invention, it is desirable that the amount of the molecular weight modifier is generally from 0.01 to 10 parts by mass, and preferably from 0.1 to 5 parts by mass, with respect to 100 parts by mass of the monovinyl monomer.

### (A-2) Suspension Process of Obtaining Suspension (Droplets Forming Process

In the present invention, the polymerizable monomer composition containing at least a polymerizable monomer, a colorant and a charge control agent is dispersed in an aqueous medium containing a dispersion stabilizer, and a polymerization initiator is added therein. Then, the polymerizable monomer composition are formed into droplets.

The method for forming the droplets is not particularly limited. For example, the droplets are formed by means of a device capable of strong agitation, such as an (in-line type) emulsifying and dispersing machine (product name: Milder, manufactured by: Pacific Machinery & Engineering Co., Ltd.) and a high-speed emulsifying and dispersing machine (product name: T. K. Homomixer Mark II, manufactured by: PRIMIX Corporation).

As the polymerization initiator, examples include, but are not limited to, persulfates such as potassium persulfate and ammonium persulfate; azo compounds such as 4,4′-azobis (4-cyanovaleric acid), 2,2′-azobis(2-methyl-N-(2-hydrosyethyl)propionamide), 2,2′-azobis(2-amidinopropane)dihydrochloride, 2,2′-azobis(2,4-dimethylvaleronitrile) and 2,2′-azobisisobutyronitrile; and organic peroxides such as di-t-butylperoxide, benzoylperoxide, t-butylperoxy-2-ethylhexanoate, t-butylperoxy diethylacetate, t-hexylperoxy-2-ethylbutanoate, diisopropylperoxydicarbonate, di-t-butylperoxylsophthalate and t-butylperoxyisobutyrate. They can be used alone or in combination of two or more kinds. Of them, organic peroxides are preferred since they can reduce residual polymerizable monomer and impart excellent printing durability.

Among organic peroxides, peroxy esters are preferred, and non-aromatic peroxy esters, i.e., peroxy esters having no aromatic ring are more preferred, since they have excellent initiator efficiency and can reduce residual polymerizable monomer.

The polymerization initiator may foe added after the polymerizable monomer composition is dispersed in the aqueous medium and before the polymerizable monomer composition is formed into droplets as described above, or it may be added to the polymerizable monomer composition before the polymerizable monomer composition is dispersed into the aqueous medium.

The added amount of the polymerization initiator used for the polymerization of the polymerizable monomer composition, is preferably from 0.1 to 20 parts by mass, more preferably from 0.3 to 15 parts by mass, and even more preferably from 1 to 10 parts by mass, with respect to 100 parts by mass of the monovinyl monomer.

In the present invention, the aqueous medium means a medium containing water as a main component.

In the present invention, the dispersion stabilizer is preferably added to the aqueous medium. As the dispersion stabilizer, examples include, but are not limited to, inorganic compounds including: sulfates such as barium sulfate and calcium sulfate, carbonates such as barium carbonate, calcium carbonate and magnesium carbonate, phosphates such as calcium phosphate, metal oxides such as aluminum oxide and titanium oxide, and metal hydroxides such as aluminum hydroxide, magnesium hydroxide and iron (II) hydroxide; and organic compounds including: water-soluble polymers such as polyvinyl alcohol, methyl cellulose and gelatin, anionic surfactants, nonionic surfactants, and ampholytic surfactants. These dispersion stabilizers can be used alone or in combination of two or more kinds.

Among the above dispersion stabilizers, preferred are colloids of inorganic compounds, and particularly preferred is a colloid of a hardly water-soluble metal hydroxide. By using a colloid of an inorganic compound, particularly a colloid of a hardly water-soluble metal hydroxide, the colored resin particles can have a small particle size distribution, and the amount of the dispersion stabilizer remaining after washing can be small, so that the toner thus obtained can clearly reproduce an image and has excellent environmental stability.

### (A-3) Polymerization Process

Formation of the droplets is carried out as described above under (A-2). The thus-obtained aqueous dispersion medium is heated to polymerize, thereby forming an aqueous dispersion of colored resin particles. The polymerization temperature of the polymerizable monomer composition is preferably 50° C. or more, and more preferably from 60 to 95° C. The polymerization reaction time is preferably from 1 to 20 hours, and more preferably from 2 to 15 hours.

The colored resin particles may be mixed with external additives and used as a polymerization toner. It is preferable that the colored resin particles are so-called core-shell type (or “capsule type”) colored resin particles obtained by using the colored resin particles as a core layer and forming a shell layer, which is a layer that is different from the core layer, around the core layer. By covering the core layer composed of a substance having a low softening point with a substance having a higher softening point, the core-shell type colored resin particles can achieve a balance between lowering of fixing temperature and prevention of aggregation during storage.

A method for producing the above-mentioned core-shell type colored resin particles using the colored resin particles, is not particularly limited. The core-shell type colored resin particles can be produced by a conventional method. The in situ polymerization method and the phase separation method are preferable from the viewpoint of production efficiency.

Hereinafter, a method for producing the core-shell type colored resin particles by the in situ polymerization method, will be described. The core-shell type colored resin particles can be obtained by adding a polymerizable monomer for forming a shell layer (a polymerizable monomer for shell) and a polymerization initiator to the aqueous medium in which the colored resin particles are dispersed, and then polymerizing the mixture.

As the polymerizable monomer for shell, the above-mentioned polymerizable monomers can be used. Among the polymerizable monomers, it is preferable to use monomers that can provide a polymer having a Tg of more than 80° C., such as styrene, acrylonitrile and methyl methacrylate, alone or in combination of two or more kinds.

As the polymerization initiator used for polymerization of the polymerizable monomer for shell, examples include, but are not limited to, water-soluble polymerization initiators including metal persulfates such as potassium persulfate and ammonium persulfate, and azo-type initiators such as 2,2′-azobis(2-methyl-N-(2-hydroxyethyl)propionamide)and 2,2′ -azobis(2-methyl-N-(1,1-bis(hydroxymethyl)2-hydroxyethyl)propionamide). These polymerization initiators can be used alone or in combination of two or more kinds. The amount of the polymerization initiator is preferably from 0.1 to 30 parts by mass, and more preferably from 1 to 20 parts by mass, with respect to 100 parts by mass of the polymerizable monomer for shell.

The polymerization temperature of the shell layer is preferably 50° C. or more, and more preferably from 60 to 95° C. The polymerization reaction time is preferably from 1 to 20 hours, and more preferably from 2 to 15 hours.

### (A-4) Washing, Filtering, Dehydrating and Drying Processes

After the polymerization is completed, the aqueous dispersion of the colored resin particles obtained by the polymerization is preferably subjected to operations of filtering, washing for removal of the dispersion stabilizer, dehydrating and drying, several times as needed, according to a conventional method.

In the washing method, when the inorganic compound is used as the dispersion stabilizer, it is preferable to add acid or alkali to the aqueous dispersion of the colored resin particles, thereby dissolving the dispersion stabilizer in water and removing it. When the colloid of the hardly water-soluble inorganic hydroxide is used as the dispersion stabilizer, it is preferable to control the pH of the aqueous dispersion of the colored resin particles to 6.5 or less by adding acid. As the acid, examples include, but are not limited to, inorganic acids such as sulfuric acid, hydrochloric acid and nitric acid, and organic acids such as formic acid and acetic acid. Especially, sulfuric acid is suitable for its high removal efficiency and small impact on production facilities.

The dehydrating and filtering method is not particularly limited and can be selected from various known methods. As the method, examples include, but are not limited to, a centrifugal filtration method, a vacuum filtration method and a pressure filtration method. Also, the drying method is not particularly limited and can be selected from various methods.

### (B) Pulverization Method

In the case of producing the colored resin particles by employing the pulverization method, the colored resin particles are produced by the following processes. First, a binder resin, a colorant, a charge control agent, and other additives added as needed, such as a release agent, are mixed by means of a mixer such as a ball mill, a V-type mixer, FM Mixer (product name), a high-speed dissolver or an internal mixer. Next, while heating the thus-obtained mixture, the mixture is kneaded by means of a press kneader, a twin screw kneading machine, a roller or the like. The thus-obtained kneaded product is coarsely pulverized by means of a pulverizer such as a hammer mill, a cutter mill or a roller mill, finely pulverized by means of a pulverizer such as a jet mill or a high-speed rotary pulverizer, and then classified into a desired particle diameter by means of a classifier such as a wind classifier or an airflow classifier, thereby obtaining the colored resin particles produced by the pulverization method.

In the pulverization method, those that are provided under the above “(A)Suspension polymerization method” can be used as the binder resin, the colorant, the charge control agent and the other additives added as needed (such as the release agent). Similarly to the colored resin particles obtained by the above “(A) Suspension polymerization method”, the colored resin particles obtained by the pulverization method can be core-shell type colored resin particles by a method such as the in situ polymerization method.

As the binder resin, resins that have been widely used for toners can be used. As the binder resin used in the pulverization method, examples include, but are not limited to, polystyrene, styrene-butyl acrylate copolymers, polyester resins and epoxy resins.

### 2. Basic Properties of the Thus-Obtained Colored Resin Particles

Hereinafter, the basic properties of the colored resin particles obtained by the production method such as the above-mentioned “(A) Suspension polymerization method” or “(B) Pulverization method” will be described. The colored resin particles described below encompass both core-shell type colored resin particles and colored resin particles of other types.

It is preferable that the colored resin particles of the present invention are positively chargeable.

The volume average particle diameter (Dv) of the colored resin particles is preferably from 4 to 12 μm, and more preferably from 5 to 10 μm. When the volume average particle diameter (Dv) is less than 4 μm, toner flowability decreases and may deteriorate transferability or decrease image density. When the volume average particle diameter (Dv) is more than 12 μm, image resolution may decrease.

For the colored resin particles, the ratio (Dv/Dn) of the volume average particle diameter (Dv) and the number average particle diameter (Dn) is preferably from 1.0 to 1.3, and more preferably from 1.0 to 1.2. When the ratio Dv/Dn is more than 1.3, there may be a decrease in transferability, image density and resolution. The volume average particle diameter and number average particle diameter of the colored resin particles can be measured by means of a particle size analyzer (product name: Multisizer, manufactured by: Beckman Coulter, Inc.), for example.

The average circularity of the colored resin particles of the present invention is preferably from 0.96 to 1.00, more preferably from 0.97 to 1.00, and even more preferably from 0.98 to 1.00, from the viewpoint of image reproducibility. When the average circularity of the colored resin particles is less than 0.96, thin line reproducibility in printing may deteriorate.

In the present invention, “circularity” is defined as a value obtained by dividing the perimeter of a circle having the same area as the projected area of a particle image by the perimeter of the particle image. Also in the present invention, “average circularity” is used as a simple method, for quantitatively representing the shape of the particles and is an indicator that shows the degree of the surface roughness of the colored resin particles. The average circularity is 1 when the colored resin particles are perfectly spherical, and it gets smaller as the surface shape of the colored resin particles becomes more complex.

### 3. Method for Producing the Toner for Developing Electrostatic Images According to the Present Invention

In the present invention, the colored resin particles are mixed and stirred with the external additives to attach the external additives to the surface of the colored resin particles, thereby obtaining a one-component toner (developer).

The one-component toner may be mixed and stirred with carrier particles to obtain a two-component developer.

The toner of the present, invention contains, as the external additives, the zinc oxide particles having a number average particle diameter of from 0.1 to 2.0 μm and the alumina particles having a number average particle diameter of from 0.05 to 1.0 μm.

When the number average particle diameter of the zinc oxide particles is less than 0.1 μm, initial fog is highly likely to occur in a high temperature and high humidity (H/H) environment. On the other hand, when the number average particle diameter of the zinc oxide particles is more than 2.0 μm, printing durability decreases, and initial fog is highly likely to occur in a low temperature and low humidity environment. Moreover, an after endurance conveyance amount gets larger than an initial conveyance amount.

The number average particle diameter of the zinc oxide particles is preferably from 0.15 to 1.2 μm, and more preferably from 0.2 to 0.8 μm.

The number average particle diameter of the particles used in the present invention, that is, the zinc oxide particles, the alumina particles, and the below-described inorganic fine particles A and B, can be measured as follows, for example. First, for each external additive, the particle diameter of 30 or more of the particles is measured by TEM, SEM or the like. The average of the measured particle diameters is determined as the number average particle diameter of the particles. When the shape of the external additive particles is a plate shape, the particle diameter is the longer diameter of the plate-shaped particles. The longer diameter of the plate-shaped particles means the absolute maximum length of the base of the plate-shaped particles. In the present invention, the base of the plate-shaped particles indicates a plane that is the largest in surface area among the planes that constitute each plate-shaped particle.

There are other methods for measuring the number average particle diameter of the external additives used in the present invention. As the methods, examples include, but are not limited to, the following measurement method: for each external additive, the particles are dispersed in a dispersion medium such as water, and the thus-obtained dispersion liquid is measured by means of a particle size analyzer (product name: MICROTRAC 3300EXII, manufactured by: Nikkiso Co., Ltd.) or the like, thereby measuring the number average particle diameter.

The content of the zinc oxide particles in the toner is from 0.05 to 1.0 part by mass with respect to 100 parts by mass of the colored resin particles. The content of the zinc oxide particles is preferably from 0.3 to 0.8 part by mass, and more preferably from 0.4 to 0.6 part by mass, with respect to 100 parts by mass of the colored resin particles.

The shape of the zinc oxide particles is preferably a plate shape, and more preferably a hexagonal plate shape.

When the number average particle diameter of the alumina particles is less than 0.05 μm, there is a remarkable decrease in charge amount in a high temperature and high humidity (H/H) environment, and fog is likely to occur in ail environments. On the other hand, when the number average particle diameter of the alumina particles is more than 1.0 μm, there is a remarkable increase in charge amount in a low temperature and low humidity (L/L) environment, and fog is likely to occur in all environments.

The number average particle diameter of the alumina particles is more preferably from 0.2 to 0.7 μm, and still more preferably from 0.3 to 0.5 μm.

The content of the alumina particles in the toner is from 0.05 to 1.0 part by mass with respect to 100 parts by mass of the colored resin particles. The content of the alumina particles is preferably from 0.1 to 0.5 part by mass, and more preferably from 0.2 to 0.4 part by mass, with respect to 100 parts by mass of the colored resin particles.

In the toner for developing electrostatic images according to the present invention, the content ratio by mass of the alumina particles to the zinc oxide particles is preferably in a range of from 1:0.6 to 1:5. When the content of the zinc oxide particles is less than 1 part by mass with respect to 1 part by mass of the alumina particles, initial fog is likely to occur in a high temperature and high humidity environment. When the content of the zinc oxide particles is more than 5 parts by mass with respect to 1 part by mass of the alumina particles, printing durability may decrease in a high temperature and high humidity environment. In the toner for developing electrostatic images according to the present invention, the content ratio by mass of the alumina particles to the zinc oxide particles is more preferably in a range of from 1:1 to 1:2.6, and still more preferably in a range of from 1:1 to 1:2.0.

It is preferable that as an external additive, the toner of the present invention further contains inorganic fine particles A having a number average particle diameter of from 5 to 25 nm.

When the number average particle diameter of the inorganic fine particles A is less than 5 nm, the inorganic fine particles A easily penetrate from the surface of the colored resin particles to the inside of the colored resin particles, cannot impart sufficient flowability to the toner, and may have adverse effects on printing performance. On the other hand, when the number average particle diameter of the inorganic fine particles A is more than 25 nm, the surface porosity of the colored resin particles increases. Therefore, the proportion (coverage) of the inorganic fine particles on the surface of each colored resin particle decreases, so that sufficient flowability may not be imparted to the toner. The number average particle diameter of the inorganic fine particles A is more preferably from 7 to 25 nm, still more preferably from 7 to 20 nm, and particularly preferably from 7 to 15 nm.

The inorganic fine particles A are preferably silica or titania fine particles, and more preferably silica fine particles. Also, the inorganic fine particles A are preferably positively chargeable silica fine particles, and more preferably fumed silica. To make the inorganic fine particles A positively chargeable, the inorganic fine particles A are preferably hydrophobized with a positively chargeable hydrophobizing agent.

As the positively chargeable hydrophobizing agent, examples include, but are not limited to, aminosilane compounds such as γ-aminopropylthethoxysilane, γ-(2-aminoethyl)aminopropyltrimethoxysilane, γ-(2-aminoethyl)aminopropylmethyldimethoxysilane, aminosilane, N-(2-aminoethyl)3-aminopropyltrimethoxysilane, and N-β-(N-vinylbenzylaminoethyl)-γ-aminopropyltrimethoxysilane, and amino-modified silicone oil. They may be used alone or in combination of two or more kinds as the hydrophobizing agent.

The content of the inorganic fine particles A is preferably from 0.1 to 2.0 parts by mass, more preferably from 0.2 to 1.5 parts by mass, and still more preferably from 0.3 to 1.0 part by mass, with respect to 100 parts by mass of the colored resin particles.

When the content of the inorganic: fine particles A is less than 0.1 part by mass, the inorganic fine particles A cannot sufficiently function as an external additive and may decrease flowability or may decrease storage stability or printing durability. On the other hand, when the content of the inorganic fine particles A is more than 2.0 parts by mass, the inorganic fine particles A are likely to be released from the surface of the developer particles. Therefore, a decrease in charge property occurs in a high temperature and high humidity environment and may cause fog or decrease fixability.

As the inorganic fine particles A, positively chargeable fumed silica fine particles are preferably used. As the positively chargeable fumed silica fine particles, examples include, but are not limited to, various kinds of commercially-available products such as HDK2150 (product name, manufactured by: Clariant Corp., number average particle diameter: 12 nm), R504 (product name, manufactured by: Nippon Aerosil Co., Ltd., number average particle diameter: 12 nm), RA200HS (product name, manufactured by Nippon Aerosil Co., Ltd., number average particle diameter: 12nm) , MSP-012 (product name, manufactured by: Tayca Corporation, number average particle diameter: 16 nm), MSP-013(product name, manufactured by: Tayca Corporation, number average particle diameter: 12 nm), TG820F (product name, manufactured by: Cabot Corporation, number average particle diameter: 7 nm) and TG7120 (product name, manufactured by: Cabot Corporation, number average particle diameter: 20 nm).

It is preferable that the toner of the present invention further contains, as an external additive, inorganic fine particles B having a number average particle diameter of from 30 to 200 nm, in addition to the inorganic fine particles A.

When the number average particle diameter of the inorganic fine particles B is less than 30 nm, a decrease in spacer effect occurs and may have adverse effects on printing performance (e.g., fog). On the other hand, when the number average particle diameter of the inorganic fine particles B is more than 200 nm, the inorganic fine particles B are likely to be released from the surface of the developer particles. Therefore, the function of the inorganic fine particles B as an external additive decreases and may have adverse effects on printing performance.

The number average particle diameter of the inorganic fine particles B is more preferably from 30 to 100 nm, and still more preferably from 35 to 80 nm. The inorganic fine particles B are preferably silica or titania fine particles, more preferably silica fine particles, and still more preferably hydrophobized silica fine particles.

The content of the inorganic fine particles B is preferably from 0.1 to 2.0 parts by mass, more preferably from 0.3 to 1.8 parts by mass, and still more preferably from 0.5 to 1.5 parts by mass, with respect to 100 parts by mass of the colored resin particles.

When the content of the inorganic: fine particles B is less than 0.1 part by mass, the inorganic fine particles B cannot sufficiently function as an external additive and may have adverse effects on printing performance. On the other hand, when the content of the inorganic fine particles B is more than 2.0 parts by mass, the inorganic fine particles B are likely to be released from the surface of the developer particles. Therefore, the function of the inorganic fine particles B as an external additive decreases and may have adverse effects on printing performance.

In the present invention, hydrophobized inorganic fine particles are preferably used as the inorganic fine particles B. The inorganic fine particles B are preferably hydrophobized with a hydrophobizing agent such as a silane coupling agent, silicone oil, fatty acid, or fatty acid metal salt. As with the above-described inorganic fine particles A, the hydrophobizing agent is preferably an aminosilane compound or amino-modified silicone oil, which are positively chargeable hydrophobizing agents, and particularly preferably an amino-modified silicone oil.

Silica fine particles are preferably used as the inorganic fine particles B. As the silica fine particles, examples include, but are not limited to, various kinds of commercially-available products such as NA50Y (product name, manufactured by: Nippon Aerosil Co., Ltd., number average particle diameter: 35 nm), VPNA50H (product name, manufactured by: Nippon Aerosil Co., Ltd., number average particle diameter: 40 nm), and H05TA (product name, manufactured by: Clariant Corp., number average particle diameter: 50 nm).

The toner of the present invention may contain any one of the inorganic fine particles A and the inorganic fine particles B. More preferably, the toner of the present invention contains both the inorganic fine particles A and the inorganic fine particles B.

An agitator is used to cover the colored resin particles with the external additives. The agitator is not particularly limited, as long as it is an agitating device that can attach the external additives to the surface of the colored resin particles. For example, the colored resin particles can be covered with the external additives by means of an agitator that is capable of mixing and agitation, such as FM Mixer (product name, manufactured by: Nippon Coke & Engineering Co., Ltd.), Super Mixer (product name, manufactured by: Kawata Manufacturing Co., Ltd.), Q Mixer (product name, manufactured by: Nippon Coke & Engineering Co., Ltd.), Mechanofusion System (product name, manufactured by: Hosokawa Micron Corporation) and Mechanomill (product name, manufactured by: Okada Seiko Co., Ltd.)

### 4. Toner for Developing Electrostatic Images According to the Present Invention

When the zinc oxide particles are contained in the toner solely as an external additive, especially, initial fog in a high temperature and high humidity environment is improved. However, especially, printing durability in a high temperature and high humidity environment (resistance to fog under load of continuous printing) deteriorates. On the other hand, when the alumina particles are contained in the toner solely as an external additive, especially, printing durability in a high temperature and high humidity environment (resistance to fog under load of continuous printing) is improved. However, especially, initial fog in a high temperature and high humidity deteriorates.

For the toner for developing electrostatic images according to the present invention, due to the use of the combination of the zinc oxide particles and the alumina particles as the external additives, toner properties that are improved or deteriorated in the case of using the particles of each kind solely, do not cancel each other out, and the toner can exert only the toner properties that are improved.

Therefore, the toner for developing electrostatic images according to the present invention has the following toner properties at a high level: excellent low-temperature fixability, resistance to filming, inhibition of fog in a high temperature and high humidity environment, and excellent printing durability in a high temperature and high humidity environment.

It is preferable that the toner for developing electrostatic images according to the present invention is positively chargeable.

### EXAMPLES

Hereinafter, the present invention will be described further in detail, with reference to examples and comparative examples. However, the scope of the present invention may not be limited to the following examples.

Herein, “part(s)” and “%” are based on mass if not particularly mentioned.

Test methods used in the examples and the comparative examples are as follows.

### 1. Production of Toners for Developing Electrostatic Images

### Example 1

First, 75 parts of styrene and 25 parts of n-butyl acrylate as polymerizable monomers and 5 parts of carbon black (product name: #25B, manufactured by: Mitsubishi Chemical Corporation) as a black colorant, were dispersed by means of a media type emulsifying and dispersing machine to obtain a polymerizable monomer mixture.

To the polymerizable monomer mixture, 1 part of a charge control resin (product name: Acrybase FCA-161P, manufactured by: Fujikura Kasei Co., Ltd.) as a positively chargeable charge control agent, 5 parts of an ester wax (product name: WEP7, manufactured by: NOF Corporation) as a release agent, 0.3 part of a polymethacrylic acid ester macromonomer (product name: AA6, manufactured by: Toagosei Co., Ltd.) as a macromonomer, 0.6 part of divinylbenzene as a crosslinkable polymerizable monomer, and 1.6 parts of t-dodecyl mercaptan as a molecular weight modifier, were added, mixed and then dissolved to prepare a polymerizable monomer composition.

Separately, an aqueous solution of 6.2 parts of sodium hydroxide (alkali metal hydroxide) dissolved in 50 parts of ion-exchanged water, was gradually added to an aqueous solution of 10.2 parts of magnesium chloride (water-soluble polyvalent metal salt) dissolved in 250 parts of ion-exchanged water, while agitating at room temperature, to prepare a magnesium hydroxide colloid (hardly water-soluble metal hydroxide colloid) dispersion.

The polymerizable monomer composition was added to the magnesium hydroxide colloid dispersion and agitated at room temperature. Then, 4.4 parts of t-butylperoxy-2-ethylhexanoate (product name: Perbutyl O, manufactured by: NOF Corporation) was added thereto as a polymerization initiator. The resulting mixture was dispersed by high shear agitation at 15,000 rpm for 10 minutes, using an in-line type emulsifying and dispersing machine, thereby forming droplets of the polymerizable monomer composition.

The suspension in which the droplets of the polymerizable monomer composition were dispersed (a polymerizable monomer composition dispersion) was put in a reactor furnished with agitating blades, and the temperature thereof was raised to 90° C. to start a polymerization reaction. When the polymerization conversion rate reached almost 100%, 1 part of methyl methacrylate (a polymerizable monomer for shell) and 0.3 part of 2,2′-azobis (2-methyl-N-(2-hydroxyethyl)-propionamide) (a water-soluble polymerization initiator for shell, product name: VA-086, manufactured by: Wako Pure Chemical Industries, Ltd.) dissolved in 10 parts of ion-exchanged water, were added thereto. The reaction was continued for 4 hours at 90° C. and then stopped by water-cooling the reactor, thereby obtaining an aqueous dispersion of colored resin particles having a core-shell structure.

The aqueous dispersion of the colored resin particles was subjected to acid washing in the following manner: while the aqueous dispersion was agitated at room temperature, sulfuric acid was added thereto in a dropwise manner, until the pH of the aqueous dispersion reached 6.5 or less.

Then, the aqueous dispersion was subjected to filtration separation, and the thus-obtained solid was re-slurried with 500 parts of ion-exchanged water, and a water washing treatment (washing, filtration and dehydration) was carried out thereon several times. Next, filtration separation was carried out thereon, and the thus-obtained solid was placed in the container of a dryer and dried at 45° C. for 48 hours, thereby obtaining colored resin particles having a volume average particle diameter (Dv) of 7.8 μm, a number average particle diameter (Dn) of 6.9 μm, a particle size distribution (Dv/Dn) of 1.13, and an average circularity of 0.987.

To 100 parts of the above-obtained colored resin particles, the following external additives were added: 0.5 part of zinc oxide particles (product name: XZ-300, manufactured by: Sakai Chemical Industry Co., Ltd., hexagonal plate-shaped particles, number average particle diameter: 0.3 μm); 0.3 part of alumina particles (product name: AKP-30, manufactured by: Sumitomo Chemical Company, Limited, number average particle diameter: 0.4 μm); 0.6 part of positively chargeable fumed silica fine particles (product name: TG820F, manufactured by: Cabot Corporation, number average particle diameter: 7 nm) as the inorganic fine particles A; and 1.0 part of silica fine particles (product name: NA50Y, manufactured by: Nippon Aerosil Co., Ltd., number average particle diameter: 35 nm) as the inorganic fine particles B. They were mixed and agitated by means of a high-speed agitator (product name: FM Mixer, manufactured by: Nippon Coke & Engineering Co., Ltd.) to cover the colored resin particles with the external additives, thereby obtaining the electrostatic image developer of Example 1. Test results are shown in Table 1.

### Example 2

The toner of Example 2 was produced and tested in the same manner as Example 1, except that the type of the zinc oxide particles was changed from XZ-300 (product name, manufactured by: Sakai Chemical Industry Co., Ltd., hexagonal plate-shaped particles, number average particle diameter: 0.3 μm) to X2-100 (product name, manufactured by: Sakai Chemical Industry Co., Ltd., hexagonal plate-shaped particles, number average particle diameter: 0.1 μm) different in number average particle diameter.

### Example 3

The toner of Example 3 was produced and tested in the same manner as Example 1, except that the type of the zinc oxide particles was changed from XZ-300 (product name, manufactured by Sakai Chemical Industry Co., Ltd., hexagonal plate-shaped particles, number average particle diameter: 0.3 μm) to XZ-1000 (product name, manufactured by: Sakai Chemical Industry Co., Ltd., hexagonal plate-shaped particles, number average particle diameter: 1.0 μm) different in number average particle diameter.

### Example 4

The toner of Example 4 was produced and tested in the same manner as Example 1, except that the added amount of the zinc oxide particles was changed from 0.5 part to 0.3 part, and the added amount of the alumina particles was changed from 0.3 part to 0.2 part.

### Example 5

The toner of Example 5 was produced and tested in the same manner as Example 1, except that the added amount of the zinc oxide particles was changed from 0.5 part to 0.3 part, and the added amount of the alumina particles was changed from 0.3 part to 0.5 part.

### Example 6

The toner of Example 6 was produced and tested in the same mariner as Example 1, except that the added amount of the alumina particles was changed from 0.3 part to 0.1 part.

### Example 7

The toner of Example 7 was produced and tested in the same manner as Example 1, except that the added amount of the alumina particles was changed from 0.3 part to 0.5 part.

### Example 8

The toner of Example 8 was produced and tested in the same manner as Example 1, except that the added amount of the zinc oxide particles was changed from 0.5 part to 0.8 part.

### Example 9

The toner of Example 9 was produced and tested in the same manner as Example 1, except that the added amount of the zinc oxide particles was changed from 0.5 part to 0.3 part.

### Example 10

The toner of Example 10 was produced and tested in the same manner as Example 1, except that the type of the alumina particles was changed from AKP-30 (product name, manufactured by: Sumitomo Chemical Company, Limited, number average particle diameter: 0.4 μm; to AKF-50 (product name, manufactured by: Sumitomo Chemical Company, Limited, number average particle diameter: 0.2 μm) different in number average particle diameter.

### Example 11

The toner of Example 11 was produced and tested in the same mariner as Example 1, except that the type of the alumina particles was changed from AKP-30 (product name, manufactured by: Sumitomo Chemical Company, Limited, number average particle diameter: 0.4 μm) to AKP-15 (product, name, manufactured by: Sumitomo Chemical Company, Limited, number average particle diameter: 0.7 μm) different in number average particle diameter.

### Example 12

The toner of Example 12 was produced and tested in the same manner as Example 1, except that the inorganic fine particles A were not added.

### Example 13

The toner of Example 13 was produced and tested in the same manner as Example 1, except that the inorganic fine particles B were not added.

### Comparative Example 1

The toner of Comparative Example 1 was produced and tested in the same manner as Example 1, except, that the alumina particles were not added.

### Comparative Example 2

The toner of Comparative Example 2 was produced and tested in the same manner as Example 1, except that the zinc oxide particles were not added.

### Comparative Example 3

The toner of Comparative Example 3 was produced and tested in the same manner as Comparative Example 1, except, that the added amount of the zinc oxide particles was changed from 0.5 part to 0.8 part.

### Comparative Example 4

The toner of Comparative Example 4 was produced and tested in the same manner as Comparative Example 2, except that the added amount of the alumina particles was changed from 0.3 part to 0.8 part.

### 2. Evaluation of Toners for Developing Electrostatic Images

The toners for developing electrostatic images of Examples 1 to 13 and Comparative Examples 1 to 4 were measured for fixing temperature, printing properties in a high temperature and high humidity condition, and filming property. The details are as follows.

### 2-1. Fixing Temperature of Toner

A fixing test was carried out by means of a commercially-available, non-magnetic one-component development printer (printing rate: 20 sheets/min) modified to be able to change the temperature of the fixing roller. In the fixing test, the temperature of the fixing roller of the modified printer was changed by 5° C., and every time the temperature was changed, the toner fixing rate at each temperature was measured.

The toner fixing rate was calculated from the ratio of image densities of a black solid area, which was printed on a test sheet by the modified printer, before and after subjected to a tape removal operation. More specifically, the toner fixing rate can be calculated by the following formula:

Fixing rate (%)=(ID (after)/ID (before))×100

where “ID (before)” is image density before the tape removal and “ID (after)” is image density after the tape removal.

In particular, the tape removal is an operation in the

following steps of: attaching a piece of an adhesive tape (product name: Scotch Mending Tape 810-3-18, manufactured by: Sumitomo 3M Limited) to the measurement part (the black solid area) on the test sheet; pressing the tape piece at a given pressure to firmly attach the tape piece; and then removing the tape piece at a constant speed in a direction along the sheet. Image density was measured by means of a reflection type densitometer (product name: RD918, manufactured by: McBeth).

In this fixing test, the minimum fixing roller temperature at which the toner fixing rate reached 80% or more, was determined as the minimum fixing temperature of the toner.

### Acceptance Criterion

In this test, for the fixing temperature required of the toner, the toner was evaluated as acceptable when the minimum fixing temperature was 165° C. or less.

### 2-2. Printing Properties (Initial Fog and Printing Durability) of Toner in High Temperature and High Humidity (H/H) Condition

In initial fog and printing durability (resistance to fog under load of continuous printing) tests, a commercially-available, non-magnetic one-component development printer (printing speed: 20 A4 sheets/min) was used. The toner cartridge of the development device was filled with the toner. Then, printing sheets were loaded in the device.

The printer was left for 24 hours in a high temperature and high humidity (H/H) environment (temperature: 35° C., humidity: 80%). Then, in the same environment, 15,000 sheets were continuously printed at an image density of 5%. Solid pattern printing (image density 100%) was carried out every 500 sheets, and the resulting black solid images were measured for image density by means of a reflection image densitometer (product name: RD918, manufactured by: Macbeth). Then, another solid pattern printing (image density 0%) was carried out. When printing halfway, the printer was stopped. A piece of an adhesive tape (product name: Scotch Mending Tape 810-3-18, manufactured by: Sumitomo 3M Limited) was attached to the toner in a non-image area on the photoconductor after development. Then, the tape piece was removed therefrom and attached to a printing sheet. Next, the whiteness degree (B) of the printing sheet on which the tape piece was attached, was measured with a whiteness colorimeter (product name: ND-1, manufactured by: Nippon Denshoku Industries Co., Ltd.) In the same manner, an unused piece of the adhesive tape was attached to the printing sheet, and the whiteness degree (A) was measured. The difference in whiteness degree (B-A) was determined as a fog value. As the fog value gets smaller, fog decreases and an excellent result is obtained.

The number of continuously printed sheets that could maintain such an image quality that the image density of the black solid image is 1.3 or more and the fog value is 3 or less, was measured. In Table 1, “15000<” indicates that such an image quality that the image density is 1.3 or more and the fog value is 3 or less, could be maintained even at the time of printing 15,000 sheets.

The fog value at the time of printing the first sheet was determined as the initial fog value.

### Acceptance Criterion

In the tests, for the printing durability required of the toner, the toner was evaluated as acceptable when the number of the continuously printed sheets was 10,000 or more. For the initial fog property required of the toner, the toner was evaluated as acceptable when the initial fog value was 2.0 or less.

### 2-3. Filming Property of Toner

In the same manner as the above 2-2, 15,000 sheets were continuously printed. Every 500 sheets, the photoconductor was visually observed to check the presence of filming.

The number of sheets on which filming was found, was determined as the number of sheets on which filming occurred. Once a filming material is formed on the photoconductor, there is a problem such that a white spot is formed on an image. Therefore, as the number of the sheets on which filming occurred increases, the toner can be said to be a preferable toner that is less likely to cause filming.

### Acceptance Criterion

In this test, for the filming property required of the toner, the toner was evaluated as acceptable when the number of sheets on which filming occurred was 10,000 or more.

Table 1 shows the evaluation results of the toners for developing electrostatic images of Examples 1 to 13 and Comparative Examples 1 to 4, along with the properties and so on of the zinc oxide particles, alumina particles, inorganic fine particles A and inorganic fine particles B.

TABLE 1

| | Example 1 | Example 2 | Example 3 | Example 4 | Example 5 | Example 6 | Example 7 | Example 8 | Example 9 |
|---|---|---|---|---|---|---|---|---|---|
| Zinc oxide | XZ-300 | XZ-100 | XZ-1000 | XZ-300 | XZ-300 | XZ-300 | XZ-300 | XZ-300 | XZ-300 |
| particles | | | | | | | | | |
| Number | 0.3 | 0.1 | 1.0 | 0.3 | 0.3 | 0.3 | 0.3 | 0.3 | 0.3 |
| average | | | | | | | | | |
| particle | | | | | | | | | |
| diameter | | | | | | | | | |
| (μm) | | | | | | | | | |
| Shape | Hexagonal | Hexagonal | Hexagonal | Hexagonal | Hexagonal | Hexagonal | Hexagonal | Hexagonal | Hexagonal |
| | plate-shaped | plate-shaped | plate-shaped | plate-shaped | plate-shaped | plate-shaped | plate-shaped | plate-shaped | plate-shaped |
| Content | 0.5 | 0.5 | 0.5 | 0.3 | 0.3 | 0.5 | 0.5 | 0.8 | 0.3 |
| (part) | | | | | | | | | |
| Alumina | AKP-30 | AKP-30 | AKP-30 | AKP-30 | AKP-30 | AKP-30 | AKP-30 | AKP-30 | AKP-30 |
| particles | | | | | | | | | |
| Number | 0.4 | 0.4 | 0.4 | 0.4 | 0.4 | 0.4 | 0.4 | 0.4 | 0.4 |
| average | | | | | | | | | |
| particle | | | | | | | | | |
| diameter | | | | | | | | | |
| (μm) | | | | | | | | | |
| Content | 0.3 | 0.3 | 0.3 | 0.2 | 0.5 | 0.1 | 0.5 | 0.3 | 0.3 |
| (part) | | | | | | | | | |
| Alumina | 1:1.7 | 1:1.7 | 1:1.7 | 1:1.5 | 1:0.6 | 1:5 | 1:1 | 1:2.7 | 1:1 |
| particles:Zinc | | | | | | | | | |
| oxide | | | | | | | | | |
| particles | | | | | | | | | |
| Inorganic | TG820F | TG820F | TG820F | TG820F | TG820F | TG820F | TG820F | TG820F | TG820F |
| fine particles | | | | | | | | | |
| A | | | | | | | | | |
| Number | 7 | 7 | 7 | 7 | 7 | 7 | 7 | 7 | 7 |
| average | | | | | | | | | |
| particle | | | | | | | | | |
| diameter | | | | | | | | | |
| (nm) | | | | | | | | | |
| Content | 0.6 | 0.6 | 0.6 | 0.6 | 0.6 | 0.6 | 0.6 | 0.6 | 0.6 |
| (part) | | | | | | | | | |
| Inorganic | NA50Y | NA50Y | NA50Y | NA50Y | NA50Y | NA50Y | NA50Y | NA50Y | NA50Y |
| fine particles | | | | | | | | | |
| B | | | | | | | | | |
| Number | 35 | 35 | 35 | 35 | 35 | 35 | 35 | 35 | 35 |
| average | | | | | | | | | |
| particle | | | | | | | | | |
| diameter | | | | | | | | | |
| (nm) | | | | | | | | | |
| Content | 1.0 | 1.0 | 1.0 | 1.0 | 1.0 | 1.0 | 1.0 | 1.0 | 1.0 |
| (part) | | | | | | | | | |
| Minimum | 160 | 165 | 160 | 155 | 160 | 155 | 160 | 165 | 155 |
| fixing | | | | | | | | | |
| temperature | | | | | | | | | |
| H/H initial | 0.2 | 0.2 | 0.6 | 0.5 | 1.5 | 0.2 | 1.1 | 0.2 | 0.8 |
| fog | | | | | | | | | |
| Number of | 15000< | 15000< | 12000 | 14000 | 15000< | 15000< | 15000< | 15000< | 14000 |
| sheets on | | | | | | | | | |
| which filming | | | | | | | | | |
| occurred | | | | | | | | | |
| H/H printing | 15000< | 13000 | 15000< | 14000 | 15000< | 11000 | 15000< | 14000 | 15000< |
| durability | | | | | | | | | |
| (sheets) | | | | | | | | | |

| | | | | | Comparative | Comparative | Comparative | Comparative |
|---|---|---|---|---|---|---|---|---|
| | Example 10 | Example 11 | Example 12 | Example 13 | Example 1 | Example 2 | Example 3 | Example 4 |
| Zinc oxide | XZ-300 | XZ-300 | XZ-300 | XZ-300 | XZ-300 | — | XZ-300 | — |
| particles | | | | | | | | |
| Number | 0.3 | 0.3 | 0.3 | 0.3 | 0.3 | — | 0.3 | — |
| average | | | | | | | | |
| particle | | | | | | | | |
| diameter | | | | | | | | |
| (μm) | | | | | | | | |
| Shape | Hexagonal | Hexagonal | Hexagonal | Hexagonal | Hexagonal | — | Hexagonal | — |
| | plate-shaped | plate-shaped | plate-shaped | plate-shaped | plate-shaped | | plate-shaped | |
| Content | 0.5 | 0.5 | 0.5 | 0.5 | 0.5 | — | 0.8 | — |
| (part) | | | | | | | | |
| Alumina | AKP-50 | AKP-15 | AKP-30 | AKP-30 | — | AKP-30 | — | AKP-30 |
| particles | | | | | | | | |
| Number | 0.2 | 0.7 | 0.4 | 0.4 | — | 0.4 | — | 0.4 |
| average | | | | | | | | |
| particle | | | | | | | | |
| diameter | | | | | | | | |
| (μm) | | | | | | | | |
| Content | 0.3 | 0.3 | 0.3 | 0.3 | — | 0.3 | — | 0.8 |
| (part) | | | | | | | | |
| Alumina | 1:1.7 | 1:1.7 | 1:1.7 | 1:1.7 | — | — | — | — |
| particles:Zinc | | | | | | | | |
| oxide | | | | | | | | |
| particles | | | | | | | | |
| Inorganic | TG820F | TG820F | — | TG820F | TG820F | TG820F | TG820F | TG820F |
| fine particles | | | | | | | | |
| A | | | | | | | | |
| Number | 7 | 7 | — | 7 | 7 | 7 | 7 | 7 |
| average | | | | | | | | |
| particle | | | | | | | | |
| diameter | | | | | | | | |
| (nm) | | | | | | | | |
| Content | 0.6 | 0.6 | — | 0.6 | 0.6 | 0.6 | 0.6 | 0.6 |
| (part) | | | | | | | | |
| Inorganic | NA50Y | NA50Y | NA50Y | — | NA50Y | NA50Y | NA50Y | NA50Y |
| fine particles | | | | | | | | |
| B | | | | | | | | |
| Number | 35 | 35 | 35 | — | 35 | 35 | 35 | 35 |
| average | | | | | | | | |
| particle | | | | | | | | |
| diameter | | | | | | | | |
| (nm) | | | | | | | | |
| Content | 1.0 | 1.0 | 1.0 | — | 1.0 | 1.0 | 1.0 | 1.0 |
| (part) | | | | | | | | |
| Minimum | 165 | 160 | 150 | 150 | 155 | 155 | 155 | 155 |
| fixing | | | | | | | | |
| temperature | | | | | | | | |
| H/H initial | 0.2 | 0.2 | 0.9 | 1.0 | 0.2 | 4.5 | 0.2 | 3.3 |
| fog | | | | | | | | |
| Number of | 15000< | 11000 | 15000< | 15000< | 13000 | 12000 | 15000< | 15000< |
| sheets on | | | | | | | | |
| which filming | | | | | | | | |
| occurred | | | | | | | | |
| H/H printing | 12000 | 12000 | 13000 | 10000 | 8000 | 15000< | 9000 | 15000< |
| durability | | | | | | | | |
| (sheets) | | | | | | | | |

### 3. Evaluation of Toners for Developing Electrostatic Images

Hereinafter, the evaluation results of the toners will be discussed with reference to Table 1.

According to Table 1, the toners of Comparative Examples 1 and 3 are toners that do not contain alumina particles. For the toner of Comparative Example 1, the minimum fixing temperature is 155° C.; the number of sheets on which filming occurred is 13,000; and the initial fog value in the high temperature and high humidity (H/H) environment is 0.2.

Therefore, the toner of Comparative Example 1 has no problem with at least low-temperature fixability, filming property, and fog in the high temperature and high humidity (H/H) environment.

However, for the toner of Comparative Example 1, the number of continuously printed sheets in the printing durability test is 8,000 and very small. This number is the smallest among Examples 1 to 13 and Comparative Examples 1 to 4. Since the toner of Comparative Example 1 does not contain alumina particles, the total amount of the external additives is smaller than the below-described toner of Example 1. However, even in the case of the toner of Comparative Example 3 (the content of the zinc oxide particles: 0.8 part) in which the same amount of external additive as the alumina particles (0.3 part) contained in the toner of Example 1 was compensated by zinc oxide particles, the number of continuously printed sheets in the printing durability test in the high temperature and high humidity (H/H) environment is as very small as 9,000.

Therefore, even though the content of the zinc oxide particles is increased, the printing durability in the high temperature and high humidity (H/H) environment cannot be improved.

Therefore, it is clear that the toners of Comparative Examples 1 and 3 that do not contain alumina fine particles have poor printing durability in the high temperature and high humidity (H/H) environment.

According to Table 1, the toners of Comparative Examples 2 and 4 are toners that do not contain zinc oxide particles.

For the toner of Comparative Example 2, the minimum fixing temperature is 155° C.; the number of sheets on which filming occurred is 12,000; and the number of continuously printed sheets in the printing durability test in the high temperature and high humidity (H/H) environment is 15,000 or more. Therefore, the toner of Comparative Example 2 has no problem with at least low-temperature fixability, filming property and printing durability in the high temperature and high humidity (H/H) environment.

However, for the toner of Comparative Example 2, the initial fog value in the high temperature and high humidity (H/H) environment is as very high as 4.5. This value is the highest among the toners of Examples 1 to 13 and Comparative Examples 1 to 4.

Since the toner of Comparative Example 2 is a toner that does not contain zinc oxide particles, the total amount of the external additives is smaller than the below-described toner of Example 1. However, even in the case of the toner of Comparative Example 4 (the content of the alumina particles: 0.8 part) in which the same amount of external additive as the zinc oxide particles (0.5 part) contained in the toner of Example 1 was compensated by alumina particles, the initial fog value in the high temperature and high humidity (H/H) environment is as very high as 3.3.

Therefore, even though the content of the alumina particles is increased, the printing durability in the high temperature and high humidity (H/H) environment cannot be improved.

Therefore, it is clear that the toners of Comparative Examples 2 and 4 that do not contain zinc oxide particles are highly likely to cause initial fog in the high temperature and high humidity (H/H) environment.

According to Table 1, the toners of Examples 1 to 13 are toners that contain, with respect to 100 parts by mass of the colored resin particles, 0.3 to 0.8 part by mass of the zinc oxide particles having a number average particle diameter of from 0.1 to 1.0 μm and 0.1 to 0.5 part by mass of the alumina particles having a number average particle diameter of from 0.2 to 0.7 μm. According to Table 1, for the toners of Examples 1 to 13, the minimum fixing temperature is as low as 165° C. or less; the number of continuously printed sheets in the printing durability test in the high temperature and high humidity (H/H) environment is as large as 10,000 or more; the initial fog value in the high temperature and high humidity (H/H) environment is as small as 1.5 or less; and the number of sheets on which filming occurred is as large as 11,000 or more.

Therefore, from the examples and comparative examples, it is clear that the toner that contains, with respect to 100 parts by mass of the colored resin particles, 0.05 to 1.0 part by mass of the zinc oxide particles having a number average particle diameter of from 0.1 to 2.0 μm and 0.05 to 1.0 part by mass of the alumina particles having a number average particle diameter of from 0.05 to 1.0 μm as external additives, is a toner for developing electrostatic images which has all of the following properties: excellent low temperature fixability, resistance to filming, inhibition of fog in the high temperature and high humidity environment, and excellent printing durability in the high temperature and high humidity environment.

The influence of differences in the content and number average particle diameter of the zinc oxide particles on the toner properties, will be discussed.

First, examples that are only different in the content of the zinc oxide particles, that is, Example 1 (content: 0.5 part), Example 8 (content: 0.8 part), Example 9 (content: 0.3 part) and Comparative Example 2 (content: 0 part) will be compared.

According to Table 1, the toner of Example 8 is slightly higher in the minimum fixing temperature and slightly worse in the printing durability in the high temperature and high humidity (H/H) environment than the toner of Example 1.

The toner of Example 9 is slightly better in the minimum fixing temperature, is slightly more likely to cause initial fog in the high temperature and high humidity (H/H) environment, and is more likely to cause filming than the toner of Example 1. As described above, the toner of Comparative Example 2 is highly likely to cause initial fog in the high temperature and high humidity (H/H) environment and is also likely to cause filming.

From the above results, the following are suggested. A best balance of effects are exerted when the content of the zinc oxide particles is about 0.5 part. As the content of the zinc oxide particles increases, initial fog in the high temperature and high humidity (H/H) environment and filming property are improved by the effect of the zinc oxide particles; meanwhile, low-temperature fixability and printing durability in the high temperature and high humidity (H/H) environment are slightly worse. Conversely, as the content of the zinc oxide particles decreases, low-temperature fixability gets better; meanwhile, initial fog is likely to occur in the high temperature and high humidity (H/H) environment, and filming is also likely to occur.

Second, examples that are only different, in the number average particle diameter of the zinc oxide particles, that is, Example 1 (average particle diameter: 0.3 μm), Example 2 (average particle diameter: 0.1 μm) and Example 3 (average particle diameter: 1.0 μm) will be compared.

According to Table 1, the toner of Example 2 is slightly worse in the minimum fixing temperature and the printing durability in the high temperature and high humidity (H/H) environment than the toner of Example 1. The toner of Example 3 is slightly more likely to cause initial fog in the high temperature and high humidity (H/H) environment and filming than the toner of Example 1.

From the above results, the following are suggested. A best balance of effects are exerted when the average particle diameter of the zinc oxide particles is about 0.3 μm. As the average particle diameter increases, initial fog in the high temperature and high humidity (H/H) environment and filming are slightly more likely to occur. As the average particle diameter decreases, the minimum fixing temperature and the printing durability in the high temperature and high humidity (H/H) environment get slightly worse.

Next, the influence of differences in the content and number average particle diameter of the alumina particles on the toner properties, will be discussed.

First, examples that are only different in the content of the alumina particles, that is. Example 1 (content: 0.3 part), Example 6 (content: 0.1 part), Example 7 (content: 0.5 part) and Comparative Example 1 (content: 0 part) will be compared.

According to Table 1, the toner of Example 7 is slightly more likely to cause initial fog in the high temperature and high humidity (H/H) environment than the toner of Example 1. The toner of Example 6 is slightly better in the minimum fixing temperature and slightly worse in the printing durability in the high temperature and high humidity (H/H) environment than the toner of Example 1. As described above, the toner of Comparative Example 1 is very poor in the printing durability in the high temperature and high humidity (H/H) environment and is slightly likely to cause filming.

From the above results, the following are suggested. A best balance of effects are exerted when the content of the alumina particles is about 0.3 part. As the content of the alumina particles increases, the printing durability in the high temperature and high humidity (H/H) environment and the filming property are improved; meanwhile, initial fog in the high temperature and high humidity (H/H) environment is likely to occur. Conversely, as the content of the alumina particles decreases, the low-temperature fixability becomes excellent; meanwhile, the printing durability in the high temperature and high humidity (H/H) environment gets worse, and filming is likely to occur.

Next, examples that are only different in the number average particle diameter of the alumina particles, that is, Example 1 (average particle diameter: 0.4 μm), Example 10 (average particle diameter: 0.2 μm) and Example 11 (average particle diameter: 0.7 μm) will be compared. According to Table 1, the toner of Example 10 is slightly worse in the minimum fixing temperature and the printing durability in the high temperature and high humidity (H/H) environment than the toner of Example 1. The toner of Example 11 is slightly worse in the printing durability in the high temperature and high humidity (H/H) environment and is slightly more likely to cause filming than the toner of Example 1.

From the above results, the following are suggested. A best balance of effects are exerted when the number average particle diameter of the alumina particles is about 0.4 μm.

As the number average particle diameter increases, the printing durability in the high temperature and high humidity (H/H) environment gets worse, and filming is likely to occur. As the number average particle diameter decreases, the printing durability in the high temperature and high humidity (H/H) environment gets slightly worse.

Next, the influence of differences in the content ratio of the alumina particles to the zinc oxide particles on the toner properties, will be discussed.

First, examples that are different in the content ratio of the alumina particles to the zinc oxide particles, that is, Example 1 (1:1.7), Example 5 (1:0.6), Example 6 (1:5), Example 7 (1:1) and Example 8 (1:2.7) will be compared.

According to Table 1, the toners of Examples 5 and 7 are slightly more likely to cause initial fog in the high temperature and high humidity (H/H) environment than the toner of Example 1. The toners of Examples 6 and 8 are slightly worse in the printing durability in the high temperature and high humidity (H/H) environment than the toner of Example 1.

From the above results, the following are suggested. A best balance of effects are exerted when the content ratio of the alumina particles to the zinc oxide particles is about 1:1.7. As the content ratio of the zinc oxide particles decreases, initial fog in the high temperature and high humidity (H/H) environment is slightly likely to occur. As the content ratio of the zinc oxide particles increases, the printing durability in the high temperature and high humidity (H/H) environment gets slightly worse.

According to Table 1, the toner of Example 12 is a toner that does not contain the inorganic fine particles A, and the toner of Example 13 is a toner that does not contain the inorganic fine particles B. According to Table 1, for both the toners of Examples 12 and 13, the minimum fixing temperature is 150° C., and the number of sheets on which filming occurred is 15,000 or more. Therefore, the toners of Examples 12 and 13 have no problem with at least low-temperature fixability and filming property.

However, for the toners of Examples 12 and 13, the initial fog value in the high temperature and high humidity (H/H) environment is relatively high, and the number of continuously printed sheets in the printing durability test in the high temperature and high humidity (H/H) environment, is relatively small.

Therefore, it is suggested that the toner that does not contain the inorganic fine particles A and the inorganic fine particles B is slightly likely to cause initial fog in the high temperature and high humidity (H/H) environment and is slightly worse in the printing durability in the high temperature and high humidity (H/H) environment.

1-8. (canceled)

9. A toner for developing electrostatic images, comprising colored resin particles containing a binder resin and a colorant, and external additives,
wherein, as the external additives, the toner contains zinc oxide particles having a number average particle diameter of from 0.1 to 2.0 μm and alumina particles having a number average particle diameter of from 0.05 to 1.0 μm; the content of the zinc oxide particles is from 0.05 to 1.0 part by mass with respect to 100 parts by mass of the colored resin particles; and the content of the alumina particles is from 0.05 to 1.0 part by mass with respect to 100 parts by mass of the colored resin particles.

10. The toner for developing electrostatic images according to claim 9, wherein a content ratio by mass of the alumina particles to the zinc oxide particles is in a range of from 1:0.6 to 1:5.

11. The toner for developing electrostatic images according to claim 9, wherein a shape of the zinc oxide particles is a plate shape.

12. The toner for developing electrostatic images according to claim 10, wherein a shape of the zinc oxide particles is a plate shape.

13. The toner for developing electrostatic images according to claim 9, wherein, as an external additive, the toner farther contains inorganic fine particles A having a number average particle diameter of from 5 to 25 nm, and a content of the inorganic fine particles A is from 0.1 to 2.0 parts by mass with respect to 100 parts by mass of the colored resin particles.

14. The toner for developing electrostatic images according to claim 12, wherein the inorganic line particles A are positively chargeable.

15. The toner for developing electrostatic images according to claim 9, wherein, as an external additive, the toner further contains inorganic fine particles B having a number average particle diameter of from 30 to 200 nm, and a content of the inorganic fine particles B is from 0.1 to 2.0 parts by mass with respect to 100 parts by mass of the colored resin particles.

16. The toner for developing electrostatic images according to claim 9, wherein the colored resin particles are positively chargeable.

17. The toner for developing electrostatic images according to claim 9, wherein the toner for developing electrostatic images is positively chargeable.
